(19) United States
(12) Patent Application Publication
(10) Pub. No.: US 2026/0065741 A1
(43) Pub. Date: Mar. 5, 2026

(54) GAMING MACHINE AND MODULAR GAMING CABINET SYSTEM WITH MICRO-LED PANELS

(71) Applicant: Konami Gaming, Inc., Las Vegas, NV (US)

(72) Inventors: Glenn Toth, Las Vegas, NV (US); Norio Tone, Las Vegas, NV (US); Gnanaprakasam Ramalingam, Las Vegas, NV (US)

(21) Appl. No.: 19/313,305

(22) Filed: Aug. 28, 2025

Related U.S. Application Data
(60) Provisional application No. 63/688,233, filed on Aug. 28, 2024.

(51) Int. Cl. G07F 17/32; F21V 8/00

(52) U.S. Cl. CPC G07F 17/3216; G02B 6/006; G02B 6/0068; G07F 17/3209; G07F 17/3211

(57) ABSTRACT

A gaming machine is described herein. The gaming machine includes a modular gaming cabinet system, a display unit assembly, and a graphics display assembly. The graphics display assembly includes a micro-LED display assembly and a graphics panel assembly. The micro-LED display assembly includes a first micro-LED side panel assembly and an opposite second micro-LED side panel assembly coupled to the modular gaming cabinet system. The graphics panel assembly includes a first etched panel lighting assembly coupled to a forward portion of the modular gaming cabinet system extending between the display unit assembly and the first micro-LED side panel assembly orientated substantially perpendicular to the first micro-LED side panel assembly, and a second etched panel lighting assembly coupled to the forward portion of the modular gaming cabinet system extending between the display unit assembly and the second micro-LED side panel assembly orientated substantially perpendicular to the second micro-LED side panel assembly.

### CROSS-REFERENCE TO RELATED APPLICATIONS

The present application claims priority to and all the benefits of U.S. Provisional Patent Application No. 63/688,233, filed on Aug. 28, 2024, the entire contents of which are expressly incorporated herein by reference.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE INVENTION

The present invention relates to gaming machines and more specifically, to a modular gaming cabinet system including micro-LED panels for use with gaming machines.

### BACKGROUND OF THE INVENTION

A gaming machine represented by a slot machine is highly popular among casino customers as a device that provides gaming that is easy to enjoy, and recent statistics report that sales from gaming machines account for the majority of casino earnings. At least some known gaming machines include a gaming cabinet enclosing a game control unit and supports a button display and one or more display monitors. Known gaming cabinets are designed to support predesigned display monitor configurations. As such, changes to the display monitor configurations are difficult and expensive. A gaming machine that enables changes in display monitor configurations is desired. The present invention addresses one or more of the aforementioned challenges.

### SUMMARY OF THE INVENTION

In one aspect of the present invention, a gaming machine is provided. The gaming machine includes a modular gaming cabinet system, a display unit assembly, and a graphics display assembly. The modular gaming cabinet system includes a cabinet stand assembly supported on a ground surface, a control unit housing assembly mounted on the cabinet stand assembly and including an inner surface defining an interior equipment cavity, and a display unit support assembly coupled to the control unit housing. The display unit support assembly includes a display support frame and a primary display support member coupled to the display support frame. The display support frame has a substantially rectangular shape and includes a forward frame portion and a rear frame portion spaced along a longitudinal axis, and a first frame sidewall and an opposite second frame sidewall spaced along a transverse axis perpendicular to the longitudinal axis and extending between the forward frame portion and the rear frame portion. The primary display support member extends outwardly from the forward frame portion along the longitudinal axis and supports the display unit assembly. The graphics display assembly is coupled to the display support frame and includes a micro-LED display assembly and a graphics panel assembly. The micro-LED display assembly includes a first micro-LED side panel assembly coupled to the first frame sidewall and an opposite second micro-LED side panel assembly coupled to the second frame sidewall. The graphics panel assembly includes a first etched panel lighting assembly coupled to the forward frame portion of the display support frame extending between the primary display support member and the first micro-LED side panel assembly orientated substantially perpendicular to the first micro-LED side panel assembly and a second etched panel lighting assembly coupled to the forward frame portion of the display support frame extending between the primary display support member and the second micro-LED side panel assembly orientated substantially perpendicular to the second micro-LED side panel assembly.

In another aspect of the present invention, a method of assembling a gaming machine is provided. The method includes providing a control unit housing assembly including an inner surface defining an interior equipment cavity and mounting a display support frame onto the control unit housing. The display support frame has a substantially rectangular shape and includes a forward frame portion and a rear frame portion spaced along a longitudinal axis, and a first frame sidewall and an opposite second frame sidewall spaced along a transverse axis perpendicular to the longitudinal axis and extending between the forward frame portion and the rear frame portion. A primary display support member is coupled to the display support frame extending outwardly from the forward frame portion along the longitudinal axis. A first micro-LED side panel assembly is coupled to the first frame sidewall and an opposite second micro-LED side panel assembly is coupled to the second frame sidewall. A first etched panel lighting assembly is coupled to the forward frame portion of the display support frame extending between the primary display support member and the first micro-LED side panel assembly orientated substantially perpendicular to the first micro-LED side panel assembly. A second etched panel lighting assembly is coupled to the forward frame portion of the display support frame extending between the primary display support member and the second micro-LED side panel assembly orientated substantially perpendicular to the second micro-LED side panel assembly.

### BRIEF DESCRIPTION OF DRAWINGS

Other advantages of the present invention will be readily appreciated as the same becomes better understood by reference to the following detailed description when considered in connection with the accompanying drawings wherein:

FIGS. 1-4 are perspective views of a gaming machine including a modular gaming cabinet system including micro-LED panel assemblies, according to embodiments of the present invention;

FIGS. 5 and 6 are exploded perspective views of the gaming machine shown in FIGS. 1-4;

FIG. 7A is a front view of the gaming machine shown in FIGS. 1-4;

FIG. 7B is a partial front view of the gaming machine shown in FIGS. 1-4 with the display unit and button deck removed;

FIG. 8 is a partial perspective view of the gaming machine shown in FIGS. 1-4;

FIG. 9 is an exploded view of the gaming machine shown in FIG. 8;

FIG. 10 is a top view of a button deck that may be used with the gaming machine shown in FIGS. 1-5;

FIGS. 11-12 are partial perspective views of the gaming machine shown in FIGS. 1-4;

FIGS. 13-15 are perspective views of a bank of gaming machines, according to embodiments of the present invention;

FIGS. 16 and 17 are perspective views of the gaming machine shown in FIGS. 1 and 2, according to embodiments of the present invention;

FIGS. 18 and 19 are partial perspective views of the gaming machine shown in FIGS. 16 and 17 with the display unit assembly removed;

FIGS. 20-24 are exploded perspective views of the gaming machine shown in FIGS. 16-19;

FIG. 25 is a perspective view of a micro-LED topper display assembly that may be used with the gaming machine shown in FIGS. 16-19;

FIG. 26 is an exploded perspective view of the micro-LED topper display assembly shown in FIG. 25; and

FIGS. 27 and 28 are perspective views of a micro-LED assembly that may be used with the micro-LED panel assemblies, according to embodiments of the present invention.

Corresponding reference characters indicate corresponding parts throughout the drawings.

### DETAILED DESCRIPTION OF EMBODIMENTS

With reference to the drawings, and in operation, the present invention is directed towards a gaming machine and a gaming cabinet system for use with gaming machines. The present invention improves the functionality of existing gaming machines by providing a gaming machine that includes a graphics display assembly including micro-light-emitting diode (micro-LED) panel assemblies that provided various graphic configurations for gaming machines to accommodate various game themes and game play using one or more micro-LED panel assemblies. By providing a graphics display assembly including micro-LED panel assemblies, the present invention improves flexibility in the design and manufacturing of gaming machines thus reducing overall operational costs and manpower.

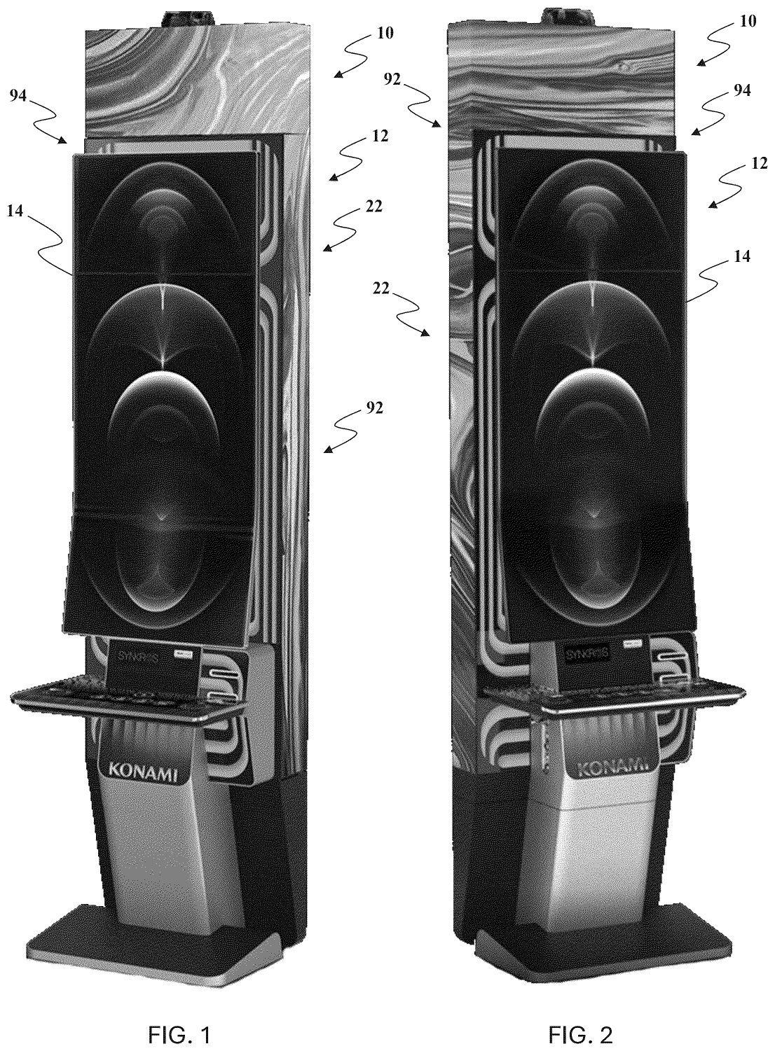

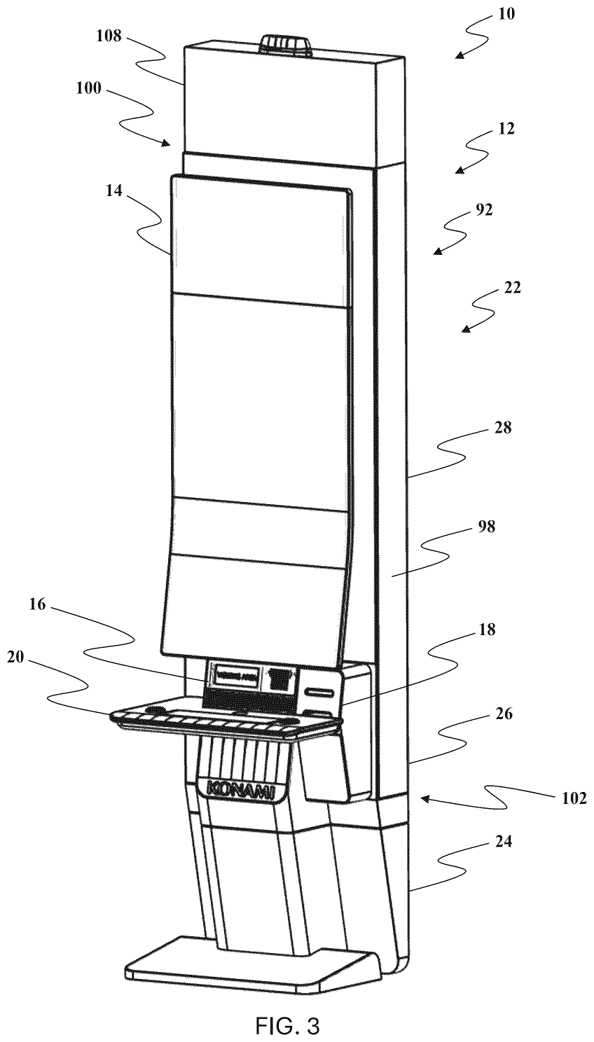

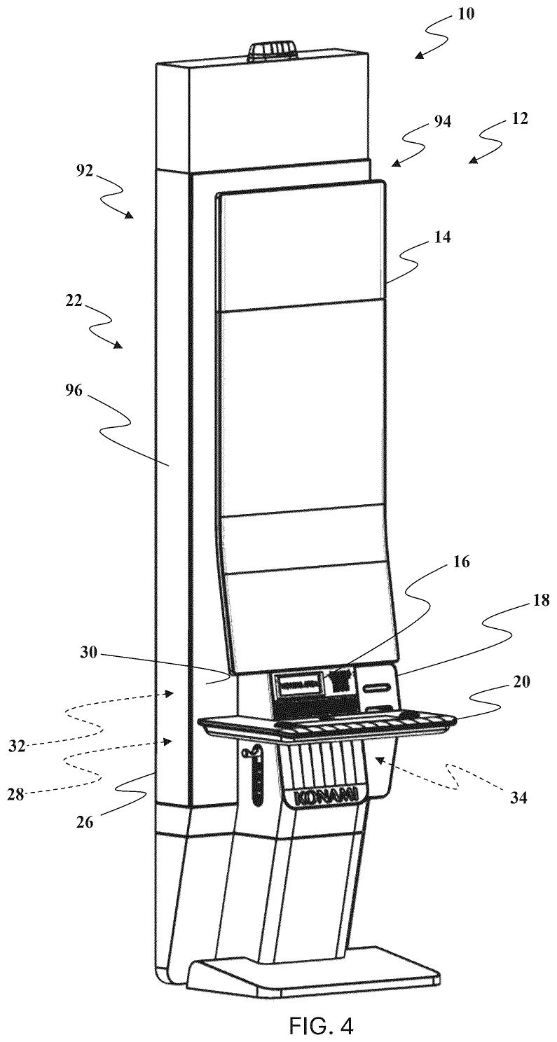

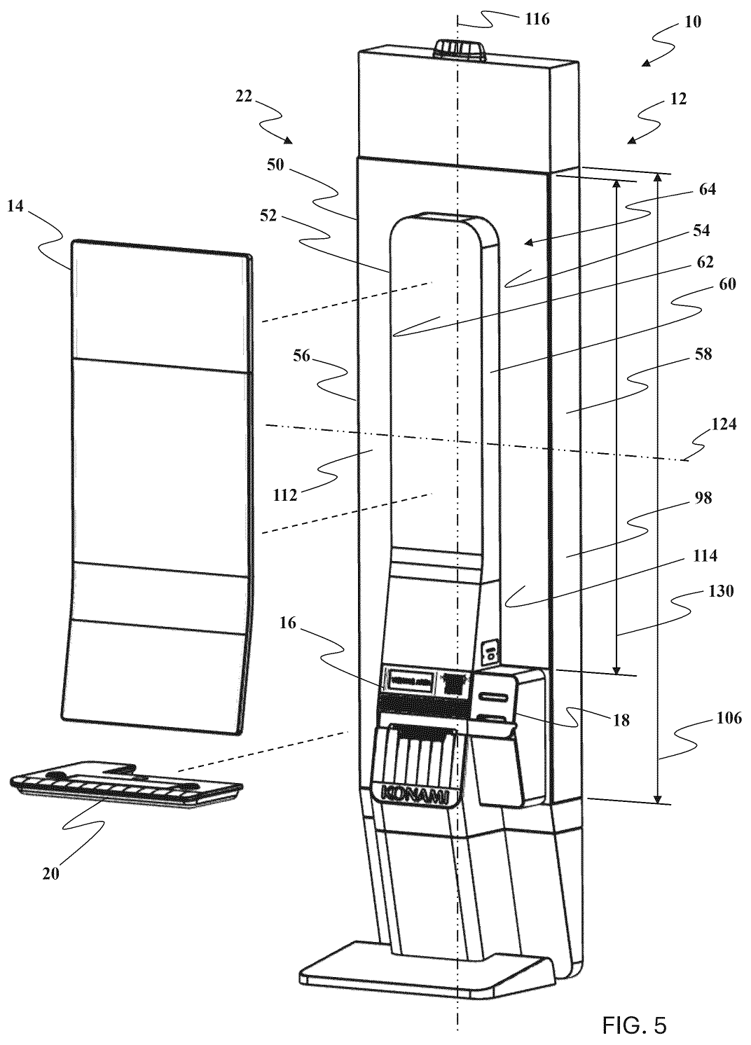

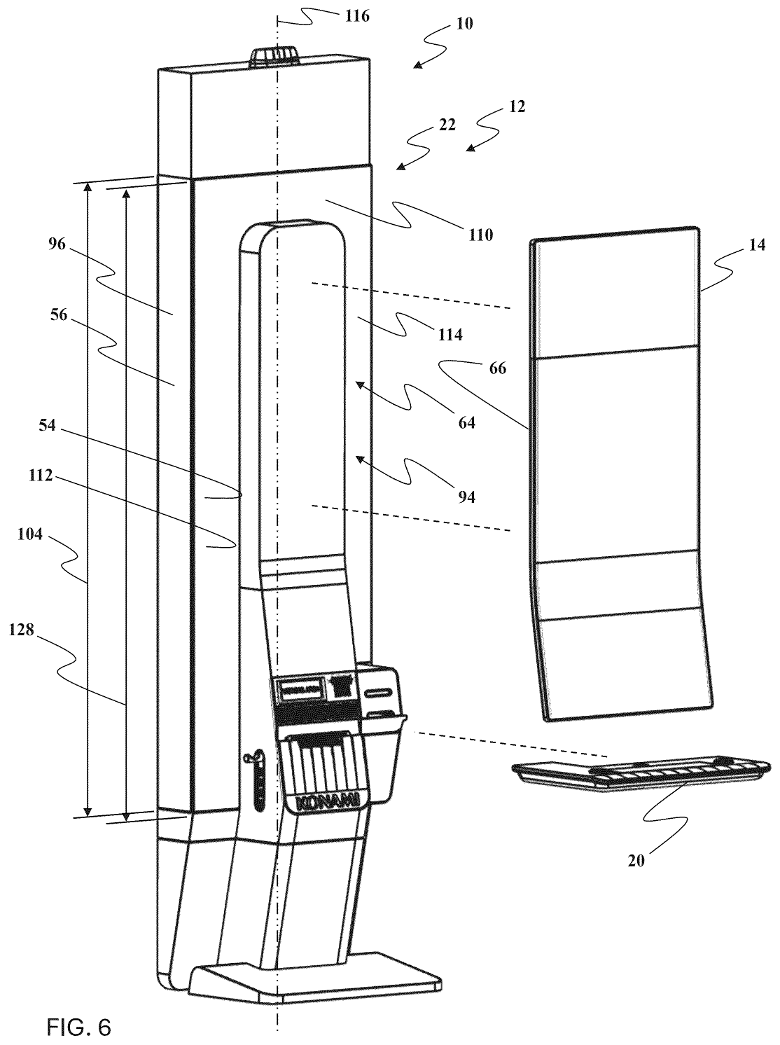

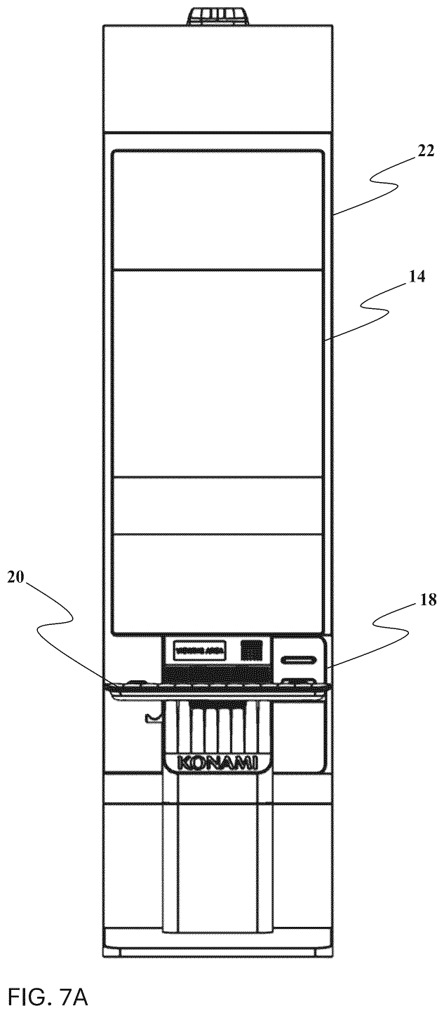

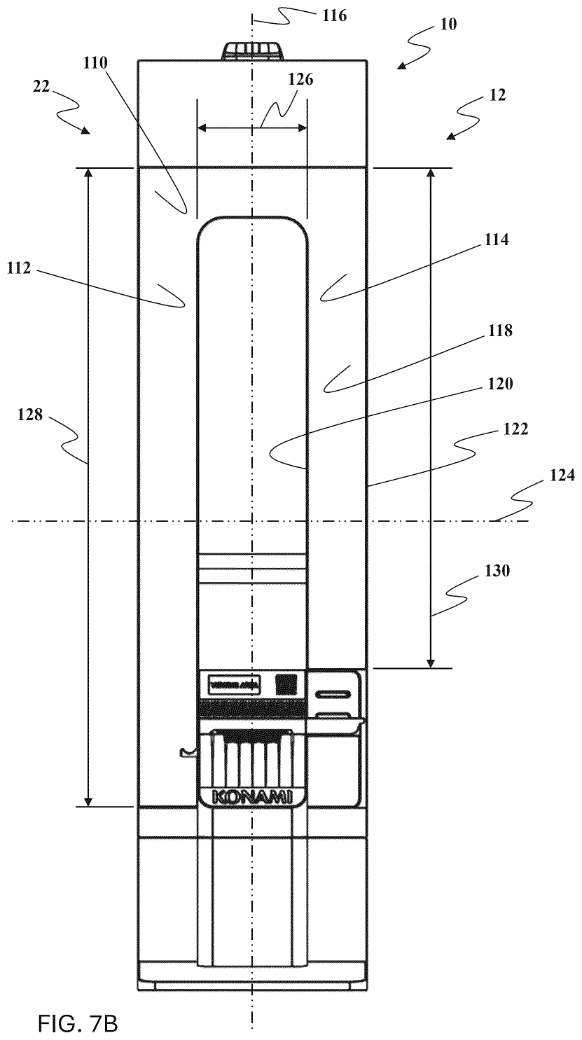

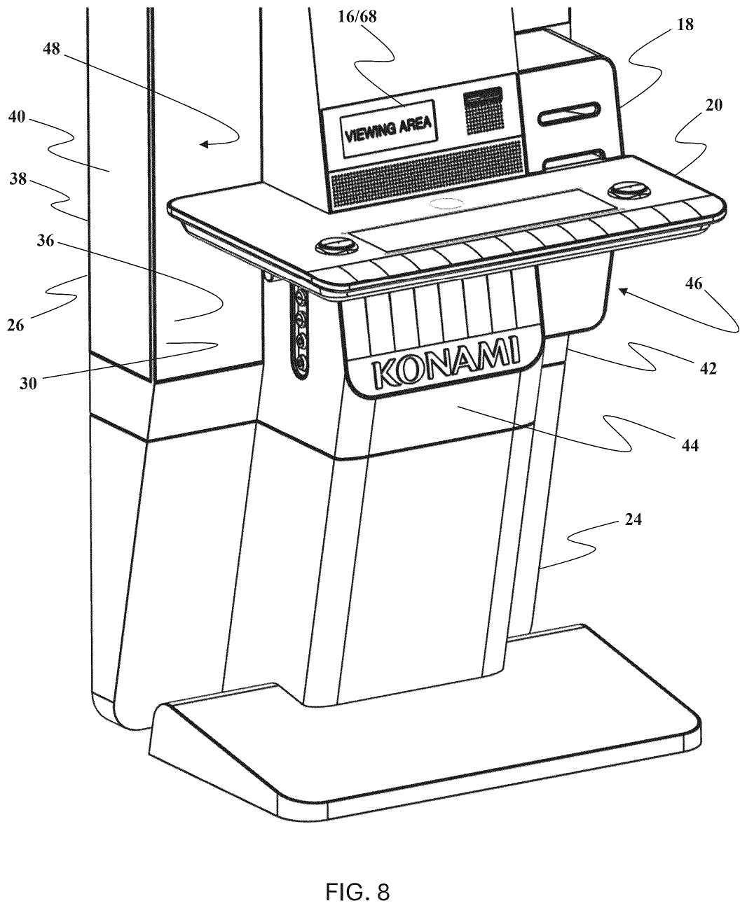

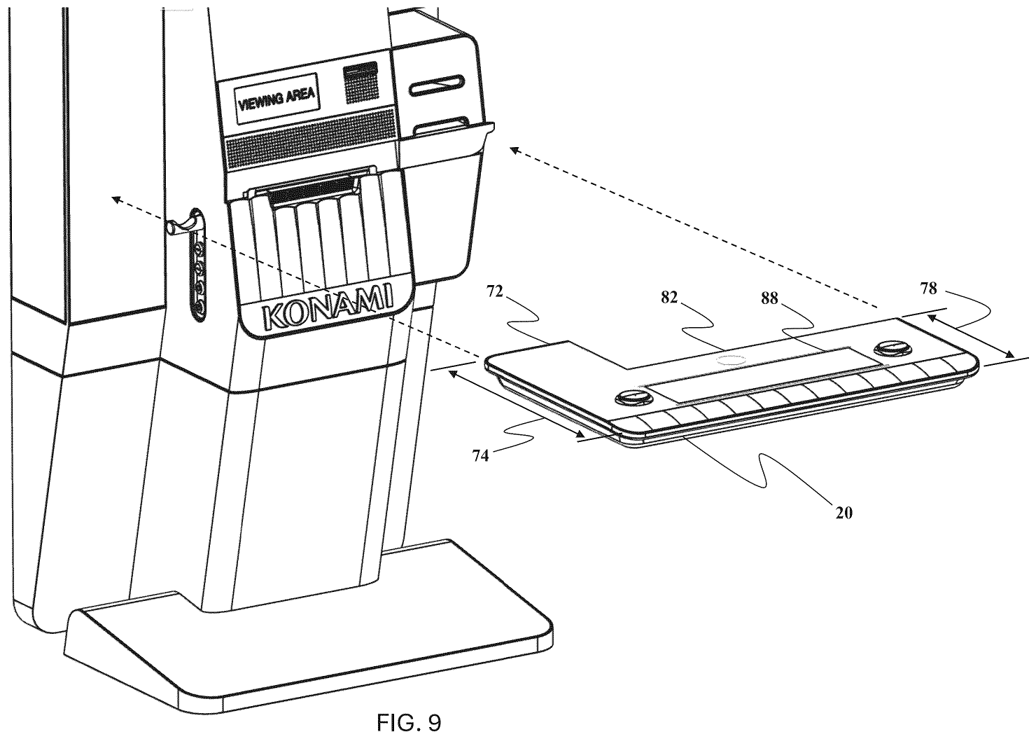

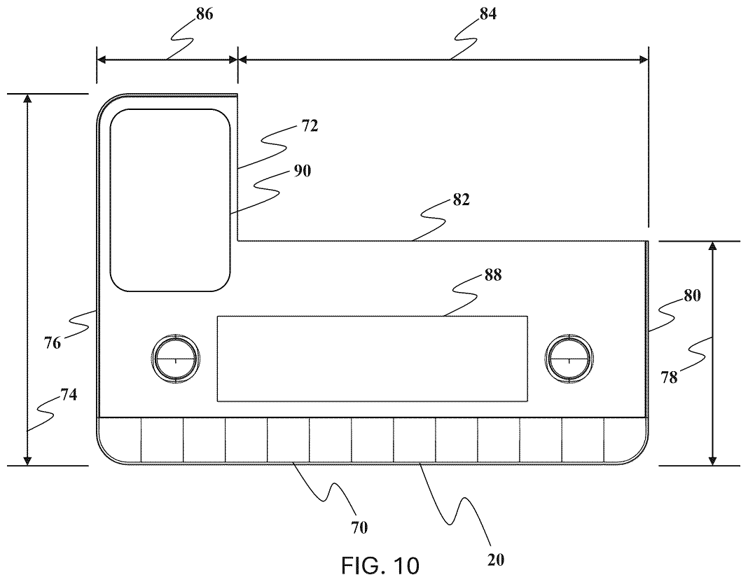

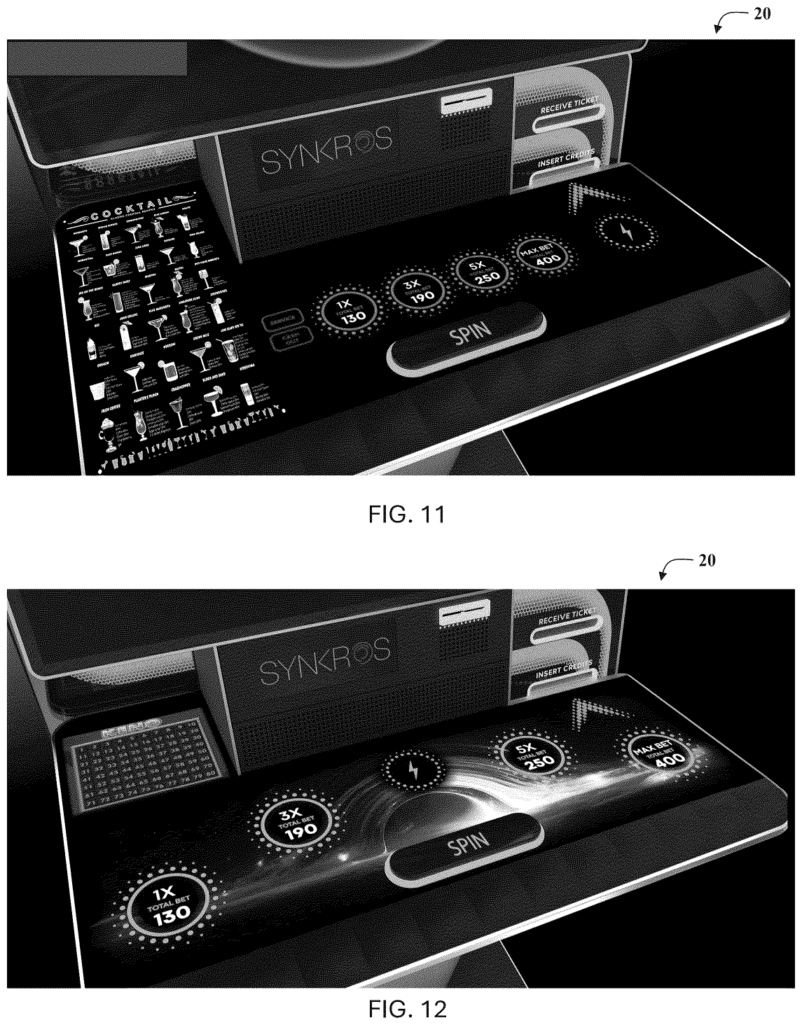

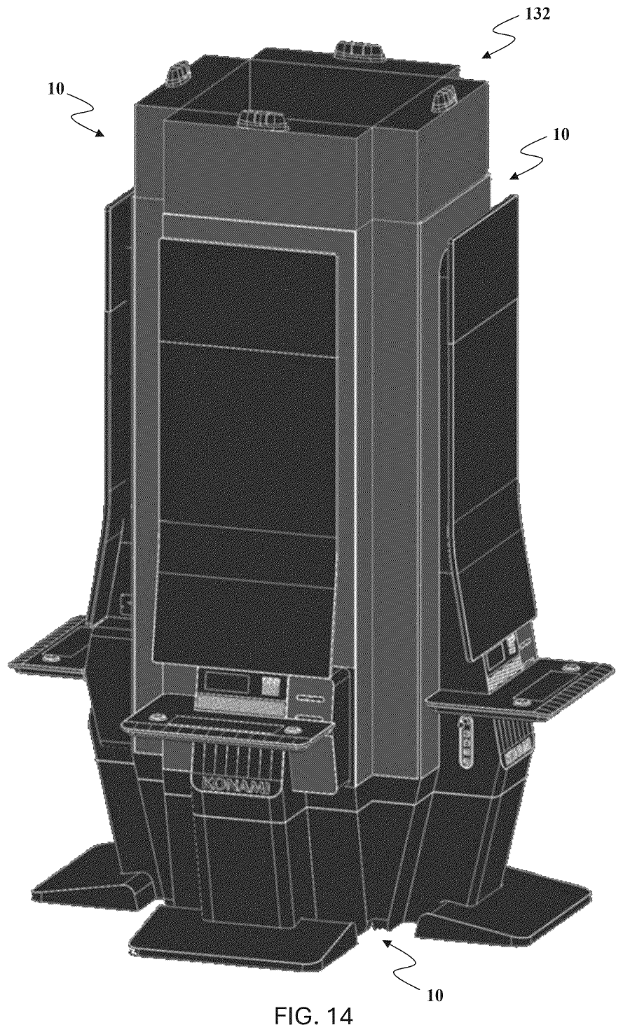

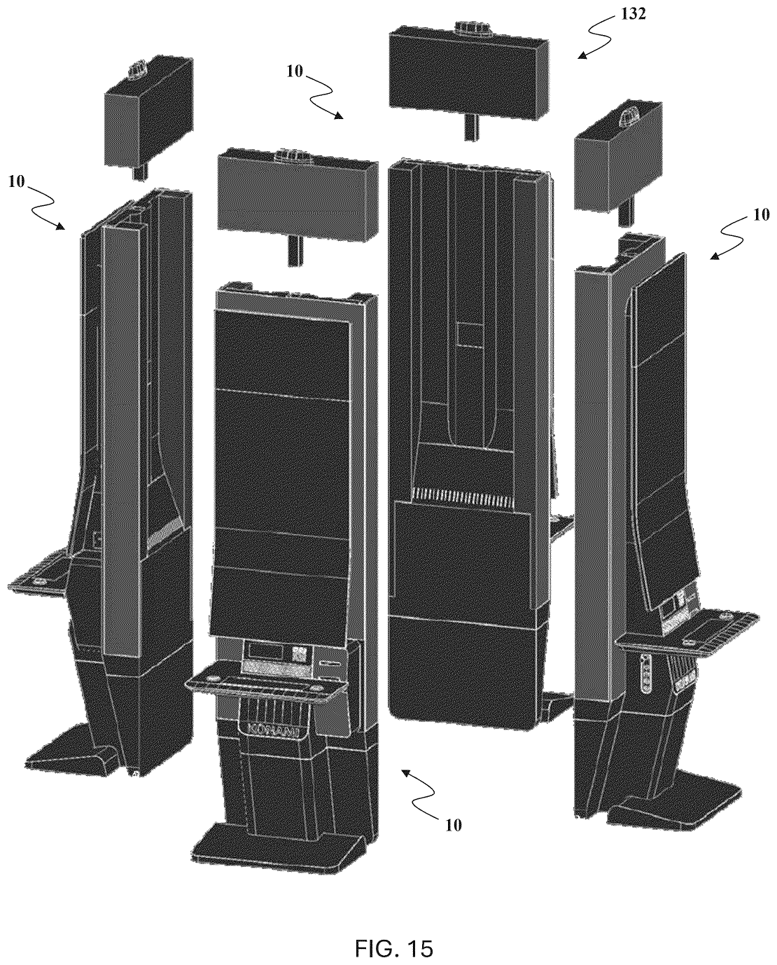

Referring to FIGS. 1-15, in the illustrated embodiment, the gaming machine 10 includes a modular gaming cabinet system 12 that supports a display unit assembly 14, a player tracking device 16, a bill/ticket assembly 18, a button panel deck 20, and a graphics display assembly 22.

The modular gaming cabinet system 12 includes a cabinet stand assembly 24 supported from a ground surface, a control unit housing assembly 26 mounted onto the cabinet stand assembly 24, and a display unit support assembly 28 mounted onto the control unit housing assembly 26.

The control unit housing assembly 26 includes an inner surface 28 and an outer surface 30. The inner surface 28 defines an interior equipment cavity 32 for housing a game control unit assembly 34 that controls each part of the gaming machine 10. The outer surface 30 includes a front outer surface 36, a rear outer surface 38 that is spaced a distance from the front outer surface 36, and a pair of opposing side surfaces 40, 42 extending between the front outer surface 36 and the rear outer surface 38. The front outer surface 36 defines a central forward portion 44 that extends outwardly from a pair of opposing first and second recessed portions 46, 48.

The display unit support assembly 28 includes a display support frame 50 and a primary display support member 52 that is coupled to the display support frame 50. The display support frame 50 includes a forward-facing outer surface 54 extending between a first frame sidewall 56 and an opposite second frame sidewall 58. The first frame sidewall 56 and the second frame sidewall 58 are each oriented substantially perpendicular to the forward-facing outer surface 54.

The primary display support member 52 includes a plurality of mounting sidewalls 60 extending substantially perpendicular outwardly from the forward-facing outer surface 54 and a mounting surface 62 extending between the plurality of mounting sidewalls 60. The primary display support member 52 extends outwardly from the forward-facing outer surface 54 of the display support frame 50 such that a gap 64 is defined between a perimeter edge of the forward-facing outer surface 54 and the plurality of mounting sidewalls 60.

The display unit assembly 14 is mounted to the mounting surface 62 of the primary display support member 52 such that the gap 64 is further defined between a rear surface 66 of the display unit assembly 14 and the forward-facing outer surface 54. The display unit assembly 14 may include one or more display units which may include liquid crystal display devices and/or organic EL display devices and the like, that are controlled by the game control unit assembly 34 to display an animated sequence of computer-generated images representing a video slot game to a player.

The player tracking device 16 is coupled to the control unit housing assembly 26 and includes a player tracking display 68 mounted within the central forward portion 44. The player tracking device 16 may also include a player card reader mounted within the central forward portion 44 that is configured to receive player identification card therein.

The bill/ticket assembly 18 is coupled to the control unit housing assembly 26 and positioned within the first recessed portion 46 adjacent to the central forward portion 44 such that an outer surface of the bill/ticket assembly 18 is substantially flush with the central forward portion 44.

The bill/ticket assembly 18 includes one or more openings for receiving bills and/or tickets therein. For example, the bill/ticket assembly 18 may include an insertion opening that a bill/ticket is inserted into, an identification part that identifies a bill/ticket by various sensors on the inside of the insertion opening is provided, and a bill/ticket storage part is provided on the outgoing side of the identification part. The bill/ticket assembly 18, receives and identifies bills/tickets (including vouchers and coupons) that are the game value as a game executing value, and notifies the game control unit assembly 34. The bill/ticket assembly 18 may also include a printer device including a ticket output opening from which a printed ticket is dispense, a printing part that prints predetermined information on a printing paper, and a housing part that houses the printing paper. The printer device under the control of the game control unit assembly 34, prints information on paper and outputs a ticket according to credit payout processing from the gaming machine 10. The output ticket can use the payout credit as game play by being inserted into the bill/ticket assembly 18 of another gaming machine, or can be exchanged for cash by a kiosk terminal inside of the casino or a casino cage. In some embodiments, the bill/ticket assembly 18 may include one or more etched panels with LED lighting mounted on an outer surface of the bill/ticket assembly 18.

The button panel deck 20 is coupled to the control unit housing assembly 26. The button panel deck 20 has an asymmetric deck design including an asymmetrical shape, and a main body portion 70 and a display arm 72 extending outwardly from the main body portion 70. The display arm 72 extends outwardly from the main body portion 70 such that the button panel deck 20 includes a first length 74 defined from a first edge 76 including the display arm 72 is longer than a second length 78 defined along a second edge 80 opposite the first edge 76. The button panel deck 20 is coupled to the control unit housing assembly 26 such that a rear edge 82 of the main body portion 70 is adjacent the central forward portion 44 and the display arm 72 is positioned within the second recessed portion 48 opposite the first recessed portion 46. The rear edge 82 of the main body portion 70 includes a first width 84 that is greater than a second width 86 of the display arm 72.

The button panel deck 20 includes a group of operational buttons that receives various instructions from the player for operating the gaming machine 10. For example, the button panel deck 20 may include a start button to receive an instruction to start an instance of the game, and a group of betting buttons to receive instructions regarding a bet amount of credits (bet number) from the player, and a payout button to receive an instruction operation instructing a credit payout accumulated in the gaming machine 10. The group of betting buttons may include one or more denomination buttons indicating different bet denominations and a max bet button to receive an instruction operation regarding the bet of the maximum amount of credits that can be bet at one time from the player.

In one embodiment, the button panel deck 20 may include one or more touchscreen panel displays that display graphical user interface (GUI) images of the operational buttons for receiving player instructions and transmitting player selections to the game control unit assembly 34. For example, in the illustrated embodiment, the button panel deck 20 may include a first touchscreen panel display 88 positioned within the main body portion 70 and configured to display a GUI of the operational buttons, and a second touchscreen panel display 90 as an additional touch deck display for exclusive Synkros™ gaming system features independent of game operation. For example, the second touchscreen panel display 90 may be configured to display a GUI including icons associated with various casino services that may be requested by the player such as, for example, restaurant reservations, food and drink orders, requesting a casino attendant, and the like. In some embodiments, the second touchscreen panel display 90 may display an additional game such as, for example, a KENO game, BINGO game, bonus game, and/or any similar video game associated with casino.

The graphics display assembly 22 is coupled to the display unit support assembly 28. The graphics display assembly 22 includes a micro-LED display assembly 92 and a graphics panel assembly 94.

The micro-LED display assembly 92 includes an integrated LED panel lighting assembly for merchandising display functionality. The micro-LED display assembly 92 includes a first micro-LED side panel assembly 96 that is coupled to the first frame sidewall 56 and a second micro-LED side panel assembly 98 that is coupled to the second frame sidewall 58. The first and second micro-LED panel assemblies 96, 98 each include a substantially rectangular shape extending vertically from a top end 100 of the display unit support assembly 28 to a bottom portion 102 of the control unit housing assembly 26, and extend substantially perpendicular from the forward-facing outer surface 54.

In the illustrated embodiment, the first micro-LED side panel assembly 96 includes a first vertical side panel length 104 that is equal to a second vertical side panel length 106 of the second micro-LED side panel assembly 98. In other embodiments, the first and second vertical side panel lengths 104, 106 may be different. In some embodiments, the micro-LED display assembly 92 may also include a micro-LED topper display assembly 108 that is mounted to the top end 100 of the display unit support assembly 28.

The graphics panel assembly 94 includes an integrated etched panel lighting assembly that is coupled to the forward-facing outer surface 54 of the display support frame 50 and is positioned within the gap 64 defined between the display unit assembly 14 and the forward-facing outer surface 54.

The graphics panel assembly 94 includes an upper body portion 110 and a pair of opposing panel arms 112, 114. The upper body portion 110 extends between the first frame sidewall 56 and the opposite second frame sidewall 58 along a top portion of the forward-facing outer surface 54. The pair of opposing panel arms 112, 114 extend from the upper body portion 110 along a vertical axis 116, and each of the opposing panel arms 112, 114 include a panel body 118 extending between an inner edge 120 and an opposite outer edge 122. The pair of opposing panel arms 112, 116 is spaced a distance apart along a horizontal axis 124 to define a support gap 126 between the inner edges 120 of the opposing panel arms 112, 114 that is sized and shaped to receive the primary display support member 52 therein such that the inner edges 120 of each opposing panel arm 112, 114 is positioned adjacent to corresponding mounting sidewalls 60 and the outer edges 122 of the panel arms are positioned adjacent to the perimeter edge of the forward-facing outer surface 54. The graphics panel assembly 94 may include etched glass/plastic panels with LED lighting and/or holographic glass panels.

In the illustrated embodiment, the pair of opposing panel arms 112, 114 includes a first panel arm 112 positioned adjacent to the first micro-LED side panel assembly 96 and a second panel arm 114 positioned adjacent to the second micro-LED side panel assembly 98. The first panel arm 112 extends from the upper body portion 110 to the display arm 72 of the button panel deck 20. The second panel arm 114 extends from the upper body portion 110 to a top end of the bill/ticket assembly 18 such that the graphics panel assembly 94 includes a first vertical graphic panel length 128 defined along the first panel arm 112 that is longer than a second vertical graphic panel length 130 defined along the second panel arm 114. In some embodiments, the first vertical graphic panel length 128 defined along the first panel arm 112 is equal to the first vertical side panel length 104 of the first micro-LED side panel assembly 96, and the second vertical graphic panel length 130 defined along the second panel arm 114 is shorter than the second vertical side panel length 106 of the second micro-LED side panel assembly 98.

The game control unit assembly 34 includes a control board equipped with a central processing unit (CPU) including a processor, an interface unit, a memory device including a memory and a storage, and the like. The control board is configured so that communication is possible through the interface unit and each of the gaming machine components including, but not limited to, the display unit assembly 14, the player tracking device 16, the bill/ticket assembly 18, the button panel deck 20, and the graphics display assembly 22, to control the operation of each part by executing the program recorded in the memory and/or the storage, and provide a game to the player. The function of the CPU is to execute and display the game on the display unit assembly 14 and accompanying advertisement and/or game related content on the graphics display assembly 22 of the gaming machine 10.

The interface unit includes a chip set providing communication functions of the CPU, a memory bus connected to a CPU, various expanding buses, serial interfaces, USB interfaces, Ethernet™ interfaces and the like, and a computer unit where the CPU provides the addressable memory and the storage through the interface unit. The memory can be configured to include RAM that is a volatile storage medium, ROM that is a nonvolatile storage medium, and EEPROM that is a rewritable nonvolatile storage medium. The storage provides the game control unit as an external storage device function, can use reading devices such as a memory card that is a removable storage medium, and a magneto optical disk and the like, and can use hard disks.

Further, the interface unit, has various communication interfaces for communicating with the exterior of the gaming machine 10, for example the interface unit can communicate with an external network by Ethernet, and a serial interface. In the present embodiment, one example shows when there is communication between a well-known server-side gaming network (Server Based Gaming), a G2S network (Game to System), and a slot information system (Slot Data System), respectively.

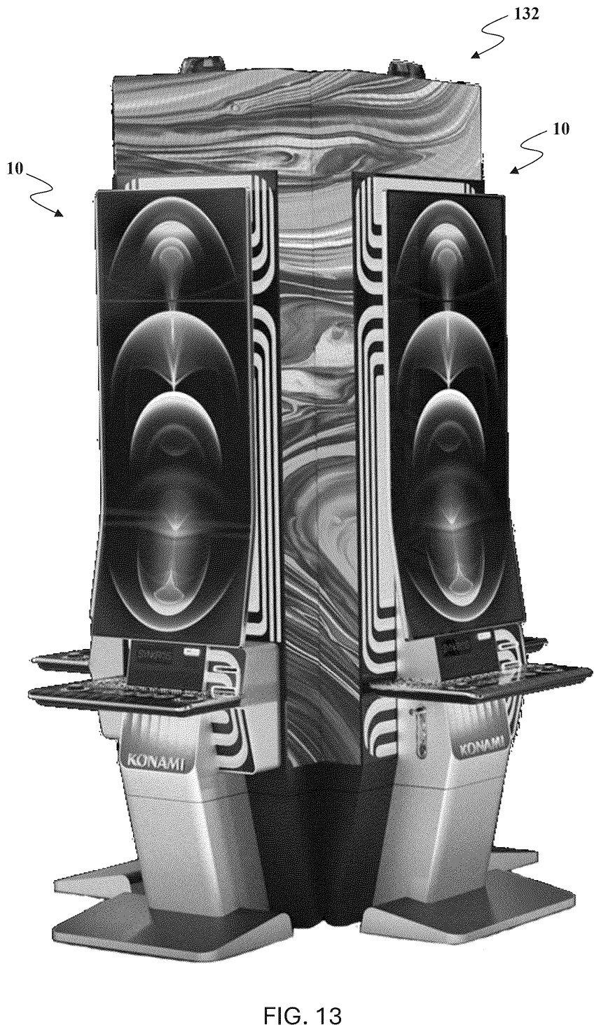

As shown in FIGS. 13-15, a plurality of gaming machines 10 may be arranged in a bank 132 of gaming machines 10 with each gaming machine 10 positioned such that an outer edge of a micro-LED side panel assembly 96, 98 is adjacent the outer edge of a corresponding micro-LED side panel assembly 96, 98 of an adjacent gaming machine 10, forming a uniform visual appearance without additional visual display panels.

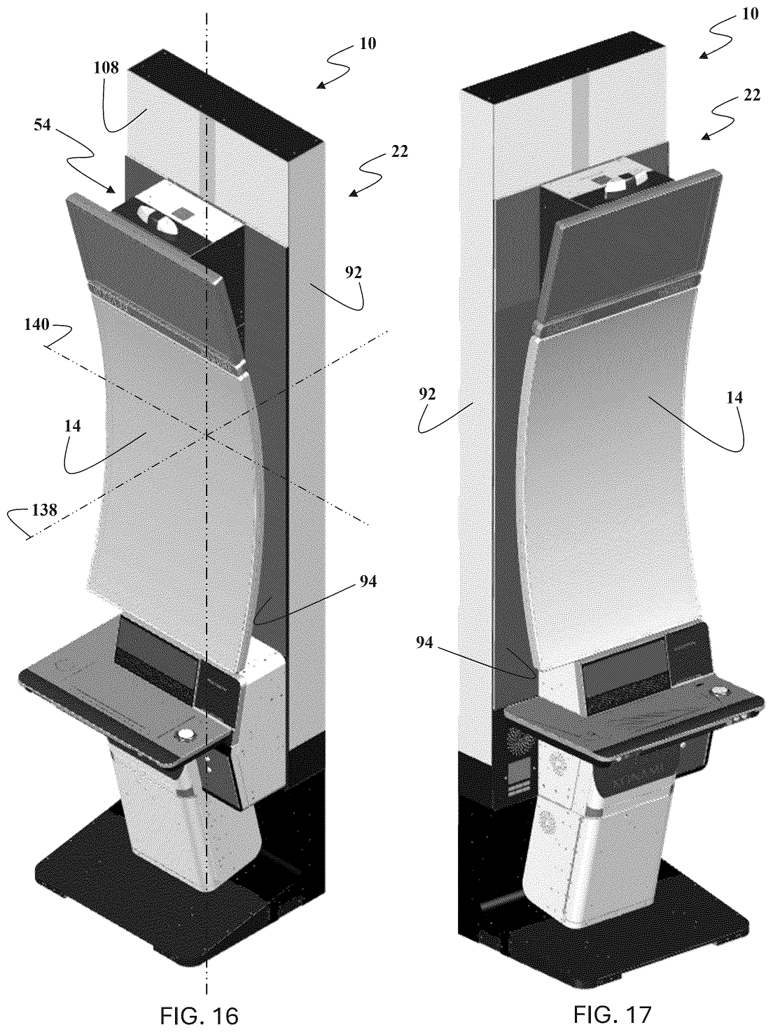

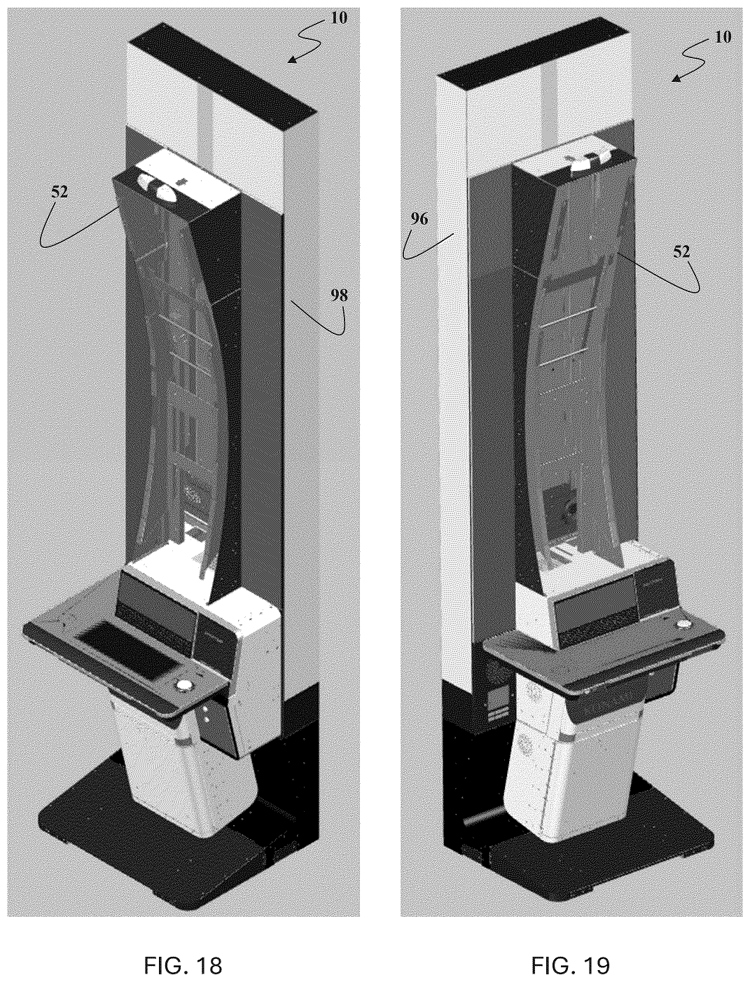

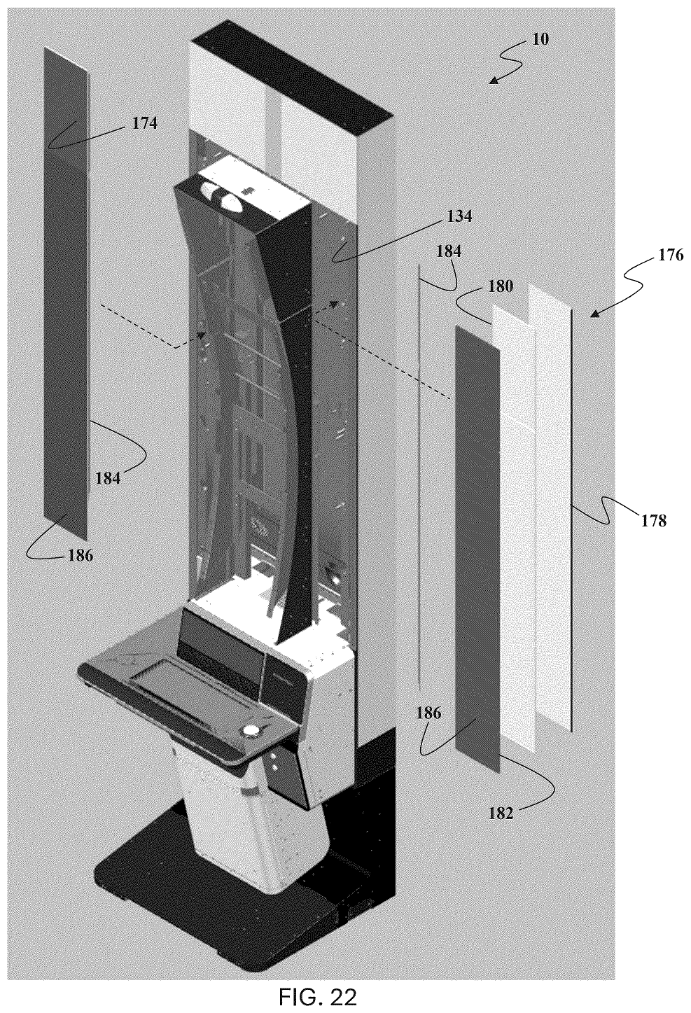

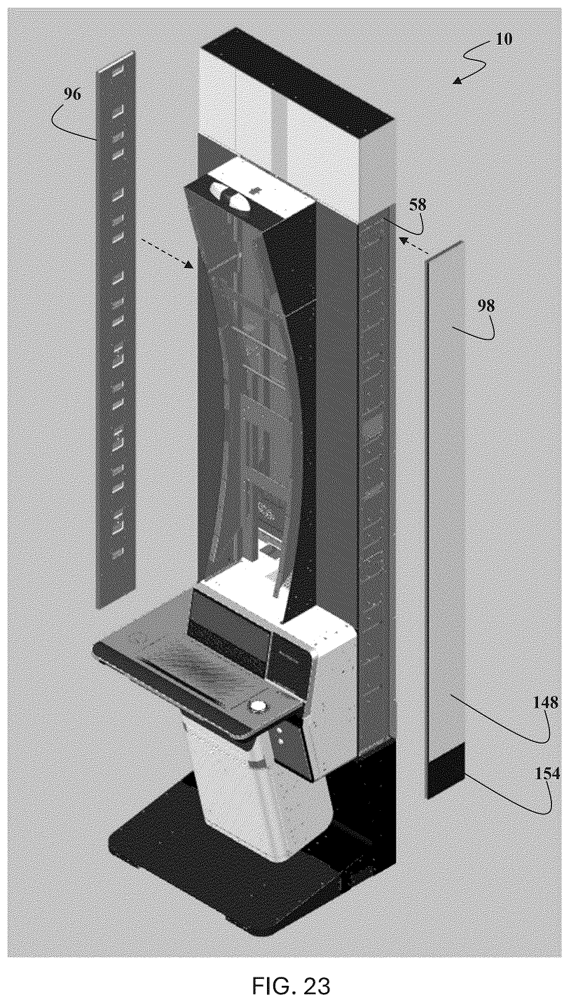

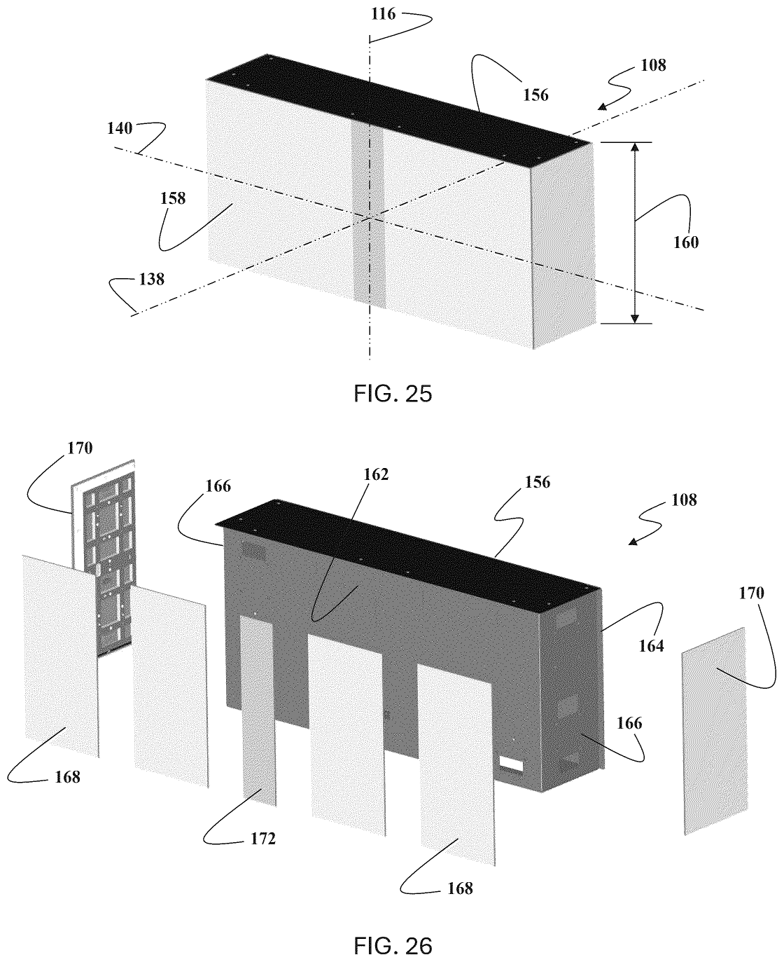

Referring to FIGS. 16-28, in the illustrated embodiment, the gaming machine 10 includes the display unit support assembly 28 coupled to the control unit housing assembly 26 and including a display support frame 50 having a substantially rectangular shape. The display support frame 50 includes a forward frame portion 134 and a rear frame portion 136 spaced a distance from the forward frame portion 134 along a longitudinal axis 138. The display support frame 50 also includes the first frame sidewall 56 and the opposite second frame sidewall 58 spaced a distance from the first frame sidewall 56 along a transverse axis 140 that is perpendicular to the longitudinal axis 138. The first frame sidewall 56 and the second frame sidewall 58 each extending between the forward frame portion 134 and the rear frame portion 136 along the longitudinal axis 138.

The primary display support member 52 is coupled to the display support frame 50 and extends outwardly from the forward frame portion 134 of the display support frame 50 along the longitudinal axis 138. The display unit assembly 14 is coupled to the primary display support member 52 such that the gap 64 is defined between the display support frame 50 and the display unit assembly 14.

The graphics display assembly 22 is coupled to the display support frame 50 and includes the micro-LED display assembly 92 and the graphics panel assembly 94.

The micro-LED display assembly 92 includes the first micro-LED side panel assembly 96 coupled to the first frame sidewall 56 and the opposite second micro-LED side panel assembly 98 coupled to the second frame sidewall 58.

The first micro-LED side panel assembly 96 and the second micro-LED side panel assembly 98 each include a width 142 defined along the longitudinal axis 138 that is substantially equal to a width 144 of the display support frame 50 defined by the first frame sidewall 56 and the second frame sidewall 58 along the longitudinal axis 138. In addition, the first micro-LED side panel assembly 96 and the second micro-LED side panel assembly 98 each include a same vertical length 104, 106 defined along the vertical axis 116.

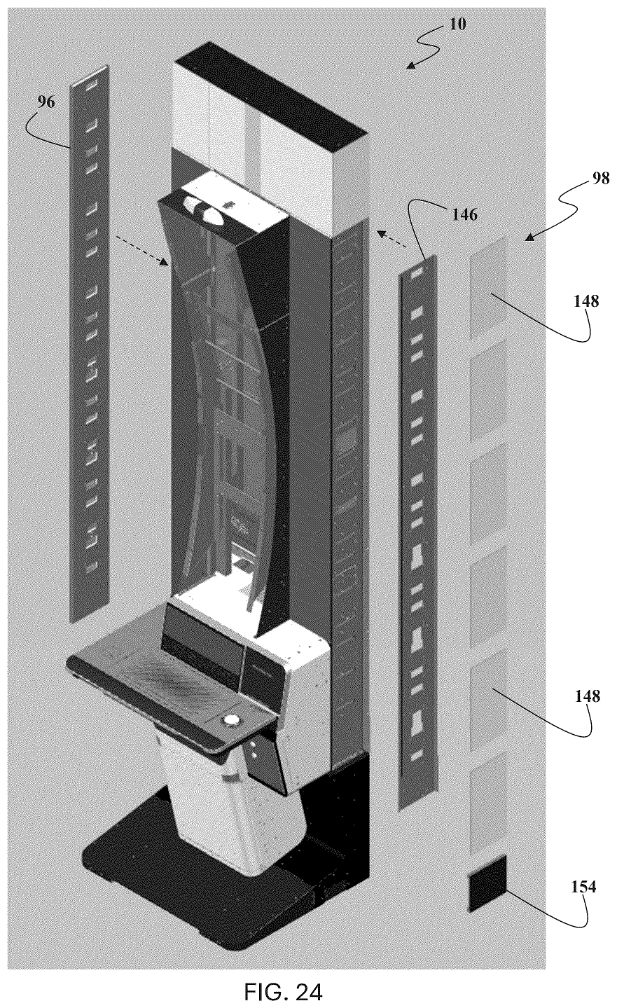

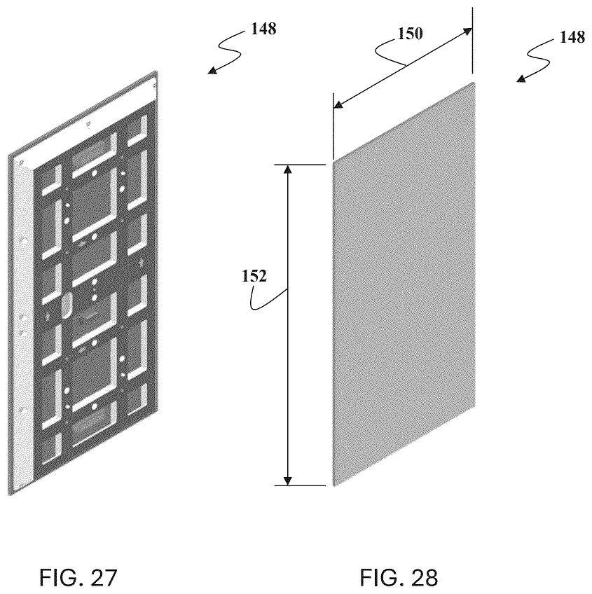

As shown in FIG. 24, in some embodiments, the first micro-LED side panel assembly 96 and the second micro-LED side panel assembly 98 each include a panel support frame 146 that is mounted to the corresponding frame sidewall 56, 58 and a plurality of side panel micro-LED assemblies 148 that are mounted to the panel support frame 146. As shown in FIGS. 27 and 28, each side panel micro-LED assembly 148 includes the same substantially rectangular cross sectional shape including the same width 150 defined along the longitudinal axis 138 and the same vertical length 152 defined along the vertical axis 116.

In some embodiments, the first micro-LED side panel assembly 96 and the second micro-LED side panel assembly 98 may each include six side panel micro-LED assemblies 148 coupled to the panel support frame 146, and a non-lighted panel 154 coupled to a bottom portion of the panel support frame 146. In other embodiments, the first micro-LED side panel assembly 96 and the second micro-LED side panel assembly 98 may include any suitable number of side panel micro-LED assemblies 148 to adjust a vertical height of the side panel assemblies 96, 98.

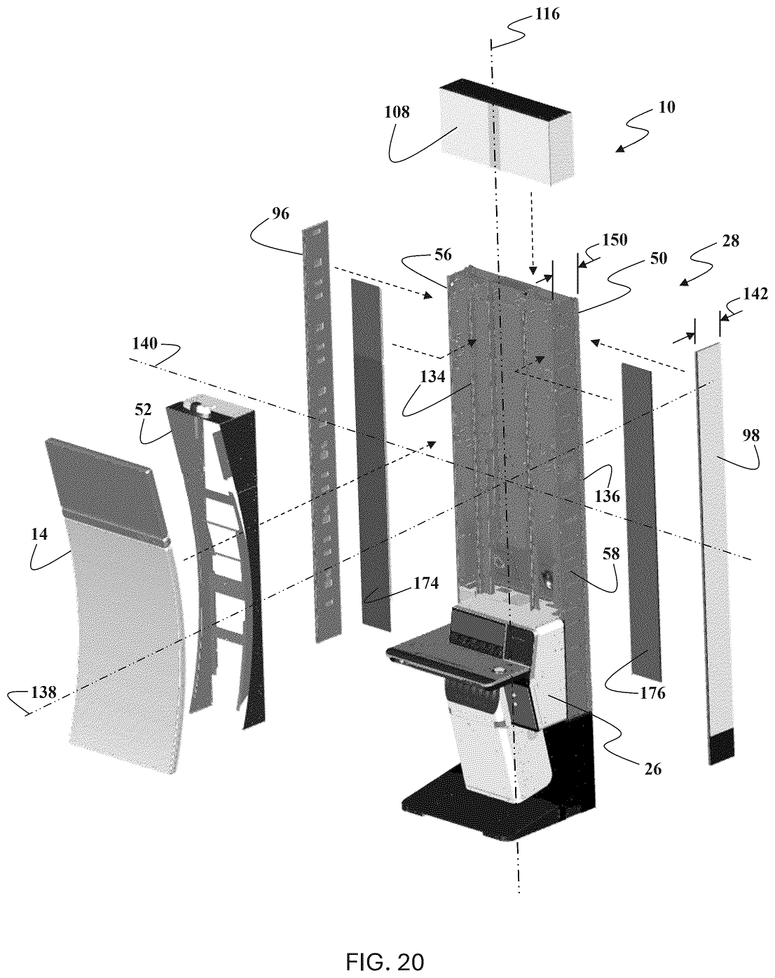

Referring to FIGS. 20 and 25-26, in some embodiments, the graphics display assembly 22 includes the micro-LED topper display assembly 108 mounted to the top end 100 of the display support frame 50. The micro-LED topper display assembly 108 includes a topper support frame 156 coupled to the display support frame 50 and a plurality of topper micro-LED assemblies 158 mounted to the outer surface of the topper support frame 156. Each of the topper micro-LED assemblies 158 includes the same vertical length 160 defined along the vertical axis 116.

The topper support frame 156 includes a substantially rectangular shape including a front surface 162 and a rear surface 164 spaced along the longitudinal axis 138, and a pair of opposing side surfaces 166 spaced along the transverse axis 140 and extending between the front surface 162 and the rear surface 164. The plurality of topper micro-LED assemblies 158 includes a plurality of forward facing micro-LED assemblies 168 that are mounted to the front surface 162 of the topper support frame 156 and a pair of opposing side facing micro-LED assemblies 170 that are mounted to the opposing side surfaces 166 of the topper support frame 156.

In some embodiments, each topper micro-LED assembly 158 may be substantially similar to the side panel micro-LED assemblies 148 and include the same substantially rectangular cross sectional shape. In other embodiments, as shown in FIG. 26, the plurality of forward facing micro-LED assemblies 168 may include a central micro-LED assembly 172 that is mounted in a center portion of the topper support frame 156 and includes a width that is less than a width of the adjacent forward facing micro-LED assemblies 168.

As shown in FIGS. 20-22, in some embodiments, the graphics panel assembly 94 includes a first etched panel lighting assembly 174 and a second etched panel lighting assembly 176 coupled to the display support frame 50. The first etched panel lighting assembly 174 is coupled to the forward frame portion 134 of the display support frame 50 and extends between the primary display support member 52 and the first micro-LED side panel assembly 96 such that the first etched panel lighting assembly 174 is orientated substantially perpendicular to the first micro-LED side panel assembly 96. The second etched panel lighting assembly 176 is coupled to the forward frame portion 134 of the display support frame 50 and extends between the primary display support member 52 and the second micro-LED side panel assembly such that the second etched panel lighting assembly 176 is orientated substantially perpendicular to the second micro-LED side panel assembly 98.

The first etched panel lighting assembly 174 and the second etched panel lighting assembly 176 each include a support panel 178 mounted to the forward frame portion 134, an adhesive layer 180 coupled to the support panel 178, an etched acrylic panel 182 affixed to the support panel 178 via the adhesive layer 180, and an LED strip 184. The etched acrylic panel 182 has a substantially rectangular shape including a graphic design etched along a panel surface 186 and a LED strip 184 orientated along a sidewall of the etched acrylic panel 182 to illuminate the graphic design.

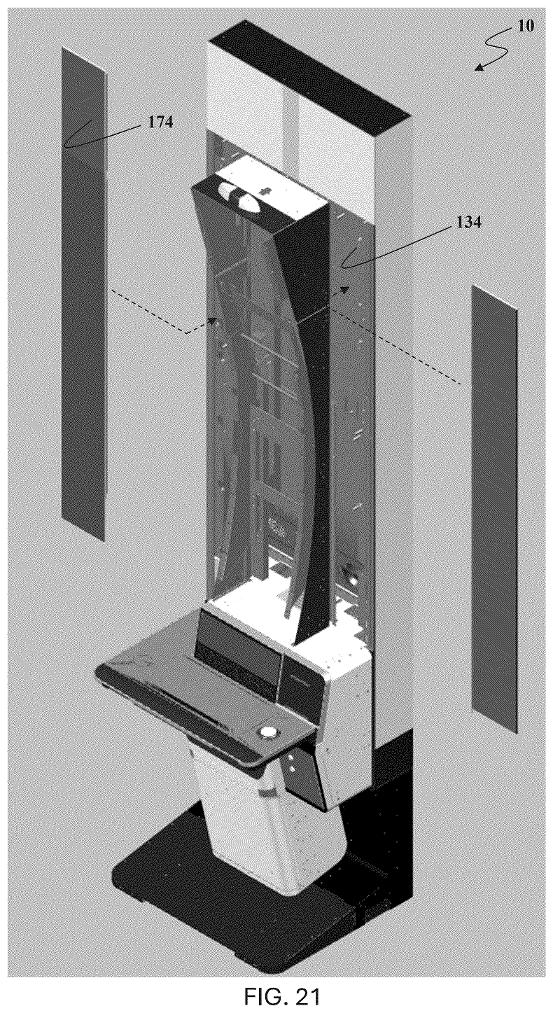

For example, as shown in FIG. 21, the first etched panel lighting assembly 174 and the second etched panel lighting assembly 176 are oriented in a mirrored relationship such that the corresponding LED strips 184 are positioned adjacent to corresponding opposing sides of the primary display support member 52. The first etched panel lighting assembly 174 and the second etched panel lighting assembly 176 also include the same width defined along the transverse axis 140.

In some embodiments, the first etched panel lighting assembly 174 extends from the top end 100 of the display support frame 50 to the button panel deck 20, and the second etched panel lighting assembly 176 extends from the top end 100 of the display support frame 50 to the bill/ticket assembly 18 such that the first etched panel lighting assembly 174 includes the first vertical graphic panel length 128 that is longer than the second vertical graphic panel length 130 of the second etched panel lighting assembly 176. The button panel deck 20 is coupled to the control unit housing assembly 26 and has an asymmetrical shape including the main body portion 70 and the display arm 72 extending outwardly from the main body portion 70 towards the display support frame 50 such that the first edge 76 of the button panel deck 20 defined along the display arm 72 includes the first length 74 that is longer than the second length 78 defined along an opposing second edge 80 of the button panel deck 20.

In some embodiments, the present invention is directed to a method of assembling the gaming machine 10. The method includes providing the control unit housing assembly 26 including the interior equipment cavity 32 and mounting the display support frame 50 onto the control unit housing assembly 26. The display support frame 50 has a substantially rectangular shape including the forward frame portion 134 and the rear frame portion 136 spaced along the longitudinal axis 138, and the first frame sidewall 56 and the opposite second frame sidewall 58 spaced along the transverse axis 140 and extending between the forward frame portion 134 and the rear frame portion 136. The method includes coupling the primary display support member 52 to the display support frame 50 such that the primary display support member 52 extends outwardly from the forward frame portion 134 along the longitudinal axis 138, coupling the first micro-LED side panel assembly 96 to the first frame sidewall, and coupling the second micro-LED side panel assembly 98 to the second frame sidewall 58. The method also includes coupling the first etched panel lighting assembly 174 to the forward frame portion 134 of the display support frame 50 extending between the primary display support member 52 and the first micro-LED side panel assembly 96 such that the first etched panel lighting assembly 174 is orientated substantially perpendicular to the first micro-LED side panel assembly 96, and coupling the second etched panel lighting assembly 176 to the forward frame portion 134 of the display support frame 50 extending between the primary display support member 52 and the second micro-LED side panel assembly 98 such that the second etched panel lighting assembly 176 is orientated substantially perpendicular to the second micro-LED side panel assembly 98.

The method may also include mounting the micro-LED topper display assembly 108 to the top end of the display support frame 50 with the micro-LED topper display assembly 108 including a topper support frame 156 and a plurality of topper micro-LED assemblies 158 mounted to an outer surface of the topper support frame 156.

The method may also include coupling the button panel deck 20 to the control unit housing assembly 26 with the button panel deck 20 having an asymmetrical shape including the main body portion 70 and the display arm 72 extending outwardly from the main body portion 70 towards the display support frame 50 such that the first edge 76 of the button panel deck 20 includes the first length 74 that is longer than the second length 78 of the opposing second edge 80 of the button panel deck 20.

Many variations of the invention will become apparent to those of skill in the art upon review of this disclosure. While the present invention has been described in connection with a variety of configurations, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

Exemplary embodiments of a gaming machine and a graphics display assembly for use with the gaming machine are described above in detail. The gaming machine and graphics display assembly are not limited to the specific embodiments described herein, but rather, components of the gaming machine and graphics display assembly may be utilized independently and separately from other components and/or steps described herein. For example, the gaming machine and graphics display assembly may also be used in combination with other gaming systems and methods, and is not limited to practice with only the gaming machine as described herein. Rather, an exemplary embodiment can be implemented and utilized in connection with many other gaming system applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A gaming machine, comprising:
a modular gaming cabinet system including:
a cabinet stand assembly supported on a ground surface;
a control unit housing assembly mounted on the cabinet stand assembly and including an inner surface defining an interior equipment cavity; and
a display unit support assembly coupled to the control unit housing assembly and including:
a display support frame having a substantially rectangular shape and including:
a forward frame portion and a rear frame portion spaced along a longitudinal axis; and
a first frame sidewall and an opposite second frame sidewall spaced along a transverse axis perpendicular to the longitudinal axis and extending between the forward frame portion and the rear frame portion; and
a primary display support member coupled to the display support frame and extending outwardly from the forward frame portion along the longitudinal axis;
a display unit assembly coupled to the primary display support member; and
a graphics display assembly coupled to the display support frame and including:
a micro-LED display assembly including a first micro-LED side panel assembly coupled to the first frame sidewall and an opposite second micro-LED side panel assembly coupled to the second frame sidewall; and
a graphics panel assembly including a first etched panel lighting assembly coupled to the forward frame portion of the display support frame extending between the primary display support member and the first micro-LED side panel assembly orientated substantially perpendicular to the first micro-LED side panel assembly and a second etched panel lighting assembly coupled to the forward frame portion of the display support frame extending between the primary display support member and the second micro-LED side panel assembly orientated substantially perpendicular to the second micro-LED side panel assembly.

2. The gaming machine of claim 1, wherein the first and second micro-LED side panel assemblies each include a width defined along the longitudinal axis that is substantially equal to a width of the display support frame defined along the longitudinal axis.

3. The gaming machine of claim 2, wherein the first and second micro-LED side panel assemblies each include a same vertical length defined along a vertical axis.

4. The gaming machine of claim 3, wherein the first and second micro-LED side panel assemblies each include a panel support frame mounted to a corresponding frame sidewall and a plurality of side panel micro-LED assemblies mounted to the panel support frame.

5. The gaming machine of claim 4, wherein each side panel micro-LED assembly includes a same substantially rectangular cross sectional shape.

6. The gaming machine of claim 4, wherein the graphics display assembly includes a micro-LED topper display assembly mounted to a top end of the display support frame and including a topper support frame and a plurality of topper micro-LED assemblies mounted to an outer surface of the topper support frame.

7. The gaming machine of claim 6, wherein the topper support frame includes a substantially rectangular shape, the plurality of topper micro-LED assemblies includes a plurality of forward facing micro-LED assemblies mounted to a front surface of the topper support frame, and a pair of opposing side facing micro-LED assemblies mounted to opposing side surfaces of the topper support frame.

8. The gaming machine of claim 7, wherein each forward facing micro-LED assembly includes a same vertical length, the plurality of forward facing micro-LED assemblies includes a central micro-LED assembly mounted in a center portion of the topper support frame and including a width that is less than a width of adjacent forward facing micro-LED assemblies.

9. The gaming machine of claim 1, wherein the first and second etched panel lighting assemblies each include an etched acrylic panel having a substantially rectangular shape including a graphic design etched along a panel surface and a LED strip orientated along a sidewall of the etched acrylic panel to illuminate the graphic design.

10. The gaming machine of claim 9, wherein the first and second etched panel lighting assemblies are oriented in a mirrored relationship such that corresponding LED strips are positioned adjacent to corresponding opposing sides of the primary display support member.

11. The gaming machine of claim 10, wherein the first and second etched panel lighting assemblies each include a same width defined along the transverse axis.

12. The gaming machine of claim 8, wherein the first etched panel lighting assembly includes a first vertical length that is longer than a second vertical length of the second etched panel lighting assembly.

13. The gaming machine of claim 1, further comprising a button panel deck coupled to the control unit housing assembly and including an asymmetrical shape.

14. The gaming machine of claim 13, wherein the button deck panel includes
a main body portion; and
a display arm extending outwardly from the main body portion towards the display support frame such that a first edge of the button panel deck defined along the display arm includes a first length that is longer than a second length of an opposing second edge of the button panel deck.

15. A method of assembling a gaming machine, comprising:
providing a control unit housing assembly including an inner surface defining an interior equipment cavity;
mounting a display support frame onto the control unit housing assembly, the display support frame having a substantially rectangular shape and including:
a forward frame portion and a rear frame portion spaced along a longitudinal axis; and
a first frame sidewall and an opposite second frame sidewall spaced along a transverse axis perpendicular to the longitudinal axis and extending between the forward frame portion and the rear frame portion;
coupling a primary display support member to the display support frame extending outwardly from the forward frame portion along the longitudinal axis;
coupling a first micro-LED side panel assembly to the first frame sidewall;
coupling an opposite second micro-LED side panel assembly to the second frame sidewall;
coupling a first etched panel lighting assembly to the forward frame portion of the display support frame extending between the primary display support member and the first micro-LED side panel assembly orientated substantially perpendicular to the first micro-LED side panel assembly; and
coupling a second etched panel lighting assembly to the forward frame portion of the display support frame extending between the primary display support member and the second micro-LED side panel assembly orientated substantially perpendicular to the second micro-LED side panel assembly.

16. The method of claim 15, wherein the first and second micro-LED side panel assemblies each include a width defined along the longitudinal axis that is substantially equal to a width of the display support frame defined along the longitudinal axis, and a same vertical length defined along a vertical axis.

17. The method of claim 16, wherein the first and second micro-LED side panel assemblies each include a panel support frame mounted to a corresponding frame sidewall and a plurality of side panel micro-LED assemblies mounted to the panel support frame; and
wherein each side panel micro-LED assembly includes a same substantially rectangular cross sectional shape.

18. The method of claim 17, further comprising mounting a micro-LED topper display assembly to a top end of the display support frame, the micro-LED topper display assembly including a topper support frame and a plurality of topper micro-LED assemblies mounted to an outer surface of the topper support frame.

19. The method of claim 15, wherein the first and second etched panel lighting assemblies each include an etched acrylic panel having a substantially rectangular shape including a graphic design etched along a panel surface and a LED strip orientated along a sidewall of the etched acrylic panel to illuminate the graphic design; and
wherein the first and second etched panel lighting assemblies are oriented in a mirrored relationship such that corresponding LED strips are positioned adjacent to corresponding opposing sides of the primary display support member.

20. The method of claim 15, further comprising coupling a button panel deck to the control unit housing assembly, the button panel deck having an asymmetrical shape and including a main body portion and a display arm extending outwardly from the main body portion towards the display support frame such that a first edge of the button panel deck defined along the display arm includes a first length that is longer than a second length of an opposing second edge of the button panel deck.
